(19) United States
(12) Patent Application Publication
(10) Pub. No.: US 2020/0203090 A1
(43) Pub. Date: Jun. 25, 2020

(54) SAFETY SWITCH FOR AN AUTOMATED INDUSTRIAL PLANT AND ASSEMBLY

(71) Applicant: Weidmüller Interface GmbH & Co. KG, Detmold (DE)

(72) Inventor: Gorm ROSE, Paderborn (DE)

(21) Appl. No.: 16/609,917

(22) PCT Filed: May 3, 2018
(86) PCT No.: PCT/EP2018/061415

§ 371 Date: Oct. 31, 2019

(30) Foreign Application Priority Data
May 11, 2017 (DE) 20 2017 102 823.2

(51) Int. Cl. H01H 3/02; H01H 23/24; H01H 23/02; H01H 23/12

(52) U.S. Cl. CPC H01H 3/0226; H01H 23/12; H01H 23/025; H01H 23/24

(57) ABSTRACT

A safety switch for an automated industrial plant includes a swivel-mounted rocker having at least one rip cord connector and at least one accelerometer arranged on the rocker. Swivel movement of the rocker is identified by evaluating signals of the accelerometer.

This application is a § 371 National Stage Entry of International Patent Application No. PCT/EP2018/061415 filed May 3, 2018. Application No. PCT/EP2018/061415 claims priority of DE 202017102823.2 filed May 11, 2017. The entire content of these applications is incorporated herein by reference.

### BACKGROUND OF THE DISCLOSURE

The invention relates to a safety switch for an industrial automated plant having at least one cord connector for a rip cord. The invention further relates to an assembly with at least one such safety switch and at least one rip cord.

In order to quickly shut down an automated industrial plant when in a dangerous situation or one of imminent danger, there is generally at least one safety switch that is accessible in the automated plant. Activating the switch typically leads to an immediate shutdown of the automated plant or to placing the automated plant in a safe operating mode, such as heavily slowing down the plant. Activating the switch might lead to a control system or a safety control system of the automated plant outputting a high priority signal so that a safe operating mode is adopted. Alternative applications, such as an arrangement of a switch with a rip cord, may also be used for process optimization. If users in a particular plant section observe imminent problems, the rip cord is pulled sending a signal to the switch so that the imminent problems may be corrected. In this regard, a safety switch can be used for process optimization.

An emergency off button is an example of a known safety switch. At larger plants, there may be many such emergency off buttons, each of which may have individual functions or are interconnected so that any switch can be used to halt the plant or to adopt the safe operating mode.

At very large automated plants, including long manufacturing lines, for example in the automotive industry, there are safety switches coupled with a rip cord. The rip cord is often arranged along an automated plant near head height so that it can be easily reached and activated. A rip cord end is mounted firmly on a plant structure and its other end is connected to the safety switch, which is a cable pull switch. When the rip cord is pulled, a signal is transmitted to the safety switch, which is thereby activated. A signal lamp may be arranged on the housing of a safety switch to signal that it has been activated, to quickly identify the area from which the signal emanates, whether to identify a safety concern or process optimization.

Safety switches are known to have fastening devices, for example an eyelet, for connection with a rip cord which can be configured to connect with a switch or activating element of another safety switch. Thus, a chain of a rip cords and safety switches can be formed which can be placed around an entire automated plant or a section of a plant.

The known safety switches have a mounted activating element which is displaced in a linear manner via a spring. For example, one eyelet is arranged on the activating element, and a rip cord is attached thereto. When the rip cord is pulled, the eyelet causes linear displacement of the activating element housing until it activates a mechanical contact switch arranged within the housing and reaches a stopping point.

Such a mechanical construction is expensive. Furthermore, care must be taken to ensure that the linear guidance of the activating element does not get caught, blocking the safety switch during an emergency. In addition, the switch must be regularly activated to keep the contact elements free of oxide layers. Otherwise, an uncertain contact might result.

### SUMMARY OF THE DISCLOSURE

Accordingly, a safety switch for connection with a rip cord for an automated industrial plant is disclosed herein. Further, a safety switch assembly having a high activation security via a simple mechanical construction, without the need for regular usage, is provided.

The safety switch includes a swivel-mounted rocker having at least one cord connector for connection with a rip cord. At least one accelerometer is arranged in or on the rocker, such that movement of the rocker is identified via accelerometer signals.

When a rip cord is pulled and the swivel-mounted rocker moves, the movement is detected via the accelerometer without activating a mechanical contact. This removes the danger of contact issues, such as contact fusion, contacts that stick, or a poor contact between the switch and activating element due to oxide on contact surfaces. The safety switch thus affords a high degree of operational security over the prior art. Further, the construction of the safety switch is simple, reducing the danger of a blockage due to a malfunction of the swivel-mounted rocker, as compared to the linear movement of known activating devices. Thus, mechanical aspects of the safety switch disclosed herein also improve reliability and security as compared to known safety switches.

In one embodiment of the safety switch, the accelerometer used is a MEMS (Micro Electro Mechanical System) sensor. Due to integration of the mechanical and electrical components of the sensor, such sensors are small and economical. Furthermore, MEMS accelerometers are used in large numbers in mobile electronic devices, such as smartphones, so they are easily and economically available.

In a further embodiment, the safety switch includes an evaluation circuit which evaluates a signal of the accelerometer and outputs a switching signal. Preferably, the evaluation circuit includes at least one threshold value detector for the signal of the accelerometer. Because the evaluation circuit is integrated in the safety switch, the acceleration information measured by the sensor can be converted directly into a switching signal and output via the evaluation circuit. Accordingly, the safety switch is compatible with known safety switches having mechanically moving contact switches, despite the fundamentally different function.

In one modification of the safety switch, the evaluation circuit includes at least two threshold value detectors for the accelerometer to distinguish between at least two different swivel movements of the rocker. Thus, an activation of the rip cord can result in a stepwise response of the automated plant. For a slight pull, for example, the automated plant may only be switched to a slower and thus safer mode, whereas a strong pull on the rip cord stops the automated plant immediately.

In an alternative embodiment, the evaluation circuit includes a timer which determines a time between a first and a second threshold value detected by the first and second threshold value detectors, respectively. With the timer, it is possible to determine the time between activating the rocker and the rocker reaching its maximum swivel angle. The first threshold value detector monitors when the rocker passes a first positive threshold value, corresponding to an acceleration in a first direction, and the second threshold value detector monitors when the rocker falls below a second negative threshold value corresponding to an acceleration in a second direction opposite the first direction.

In another embodiment of the safety switch, the rocker is pretensioned with spring loading in a base position. From this base position, movement of the rocker which is detected by the accelerometer occurs when the rip cord is pulled.

Preferably, two cord connectors such as eyelets, each for a respective rip cord, are arranged on opposite sides of the rocker, and the rocker can swivel from the base position to either side. Further, the evaluation circuit is preferably designed to distinguish, via the accelerometer signal, which of the two sides the rocker has swiveled to. Thus, a safety switch having only one accelerometer and only one evaluation circuit can monitor two rip cords and also detect specifically which of the two rip cords is activated.

In another embodiment of the safety switch, the switch includes at least one signal lamp for signaling a switching status of the safety switch. Thus, pulling of a rip cord will be indicated at the automated plant, allowing for the activation to be easily located. If the safety switch is coupled with rip cords on both sides, there are preferably at least two signal lamps each associated with one of the two sides of the rocker to signal which of the two rip cords has been activated.

In another advantageous embodiment, the safety switch includes a port for an industrial field bus to transmit a switching status of the safety switch. Similarly, an existing signal lamp can be controlled via the industrial field bus.

An assembly according to the invention includes at least one such safety switch and one rip cord connected with the safety switch.

In one modification of the assembly, at least two safety switches, each with a rip cord, are provided, with each rip cord leading from its respective safety switch to a safety light, which has corresponding cord connectors for each rip cord and each signal lamp of the safety light. A chain of safety switches, rip cords and safety lights can be formed, in which safety switches and safety lights alternate. Such safety lights have only cord connectors and signal lamps. They are not designed to detect an activation of the rip cords. By using signal lamps with the safety switch and the safety lights, the activated section of the rip cord chain can be clearly identified.

Preferably, the safety light includes a port for an industrial field bus and is designed to control a signal lamp via the industrial field bus.

### BRIEF DESCRIPTION OF THE FIGURES

Other objects and advantages of the present disclosure will become apparent from a study of the following specification viewed in light of the accompanying drawings, in which:

FIG. 1 is a schematic side view of a safety switch;

FIG. 2 is a schematic representation of an assembly with two safety switches and a safety light, as well as multiple rip cords;

FIG. 3 is a schematic side view of the safety light used in FIG. 2; and

FIG. 4 is a schematic diagram of the circuit board of the safety switch.

### DETAILED DESCRIPTION OF THE INVENTION

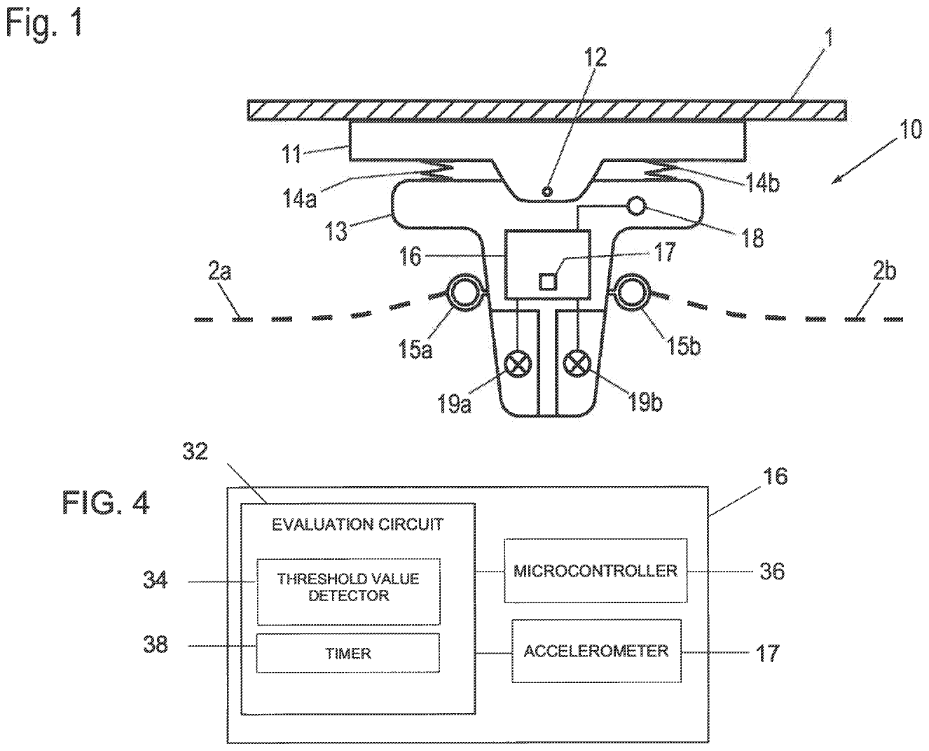

FIG. 1 shows a safety switch 10 mounted on a carrier 1. The carrier 1 is part of an automated plant, not shown, and is preferably mounted at head height or slightly above head height, so that the safety switch 10 is fastened to the carrier 1 and hangs downwardly. The safety switch 10 is also referred to herein as the switch 10.

The switch 10 includes a baseplate 11 which is fastened to the carrier 1. There is a swivel joint 12 arranged at a central lower end of the baseplate, on which a rocker 13 is mounted and able to swivel from side to side. Between the baseplate 11 and the rocker 13 are two springs 14a, 14b, which hold the rocker 13 in a neutral base position with preloading. In this base position, the rocker 13 is oriented with its top surface parallel to the baseplate 11. The rocker 13 can be tilted to either side, compressing or stretching the respective spring 14a or 14b. Though not shown, stop buffers can be arranged between the rocker 13 and the baseplate 11 to soften the end stop at the rocker's maximum swivel point.

Eyelets 15a, 15b are arranged on opposing sides of the rocker 13. The eyelets 15a, 15b serve as fastening elements for connecting the rocker 13 to a respective rip cord 2a, 2b and are arranged on the rocker 13 such that a left or right pull on one of the eyelets 15a, 15b results in a swivel of the rocker 13.

These rip cords 2a, 2b are indicated schematically by broken lines in FIG. 1, and are connected by their oppositely arranged free ends, not shown here, to a further eyelet. These further eyelets are mounted at the same or at least comparable height above the floor as the eyelets 15a, 15b of the switch 10. The rip cords 2a, 2b are not taut, but rather slightly droop to form an are. Pulling down on one of the rip cords 2a, 2b at any location of the rip cord, results in the respective eyelet 15a, 15b being pulled, by which the rocker 13 swivels to one side or the other.

Within the rocker 13 is a circuit board 16 including electronic components, one of which is an accelerometer 17, which is preferably designed as a MEMS sensor. Such a sensor is able to measure an acceleration acting on it in at least one, and possibly two or more, axes. An evaluation circuit 16a which detects and evaluates an acceleration acting on the accelerometer is also arranged on the circuit board 16. Acceleration is detected via a threshold value detector 16b of the evaluation circuit, shown in FIG. 4, which outputs a signal as soon as an absolute value of the acceleration detected by the accelerometer 17 exceeds or falls below a given value. The threshold value detector 34 is preferably controlled by a microcontroller 36.

The above elements detect movement of the rocker 13 after it is pivoted by the safety rip cord 2a, 2b without activating a mechanical contact. Thus, there is no danger of contact fusion, contacts that stick, or poor contact due to an oxide layer formed on contact surfaces. This results in a switch 10 that has a high degree of operational security. Unlike other switches, the mechanical construction of the switch 10 is very simple, with only the slight danger of the swivel joint 12 being blocked. Accordingly, there is also a high functional security.

In one embodiment of the switch 10, the region between the baseplate 11 and the rocker 13 is enclosed by a frame or it includes a bellows so that the danger of materials or dirt getting into the region between the rocker and the baseplate and limiting the freedom of movement of the rocker 13 is reduced.

The circuit board 16 and the evaluation circuit are connected to ports 18 which connect the switch 10 to an automated industrial plant. The ports 18 are arranged on the rocker 13 and therefore move with the rocker 13 when it is activated. The rocker preferably moves in a range of a few millimeters up to a maximum of one or two centimeters, so that there are no issues with the associated movement of the ports and the cables connected to them.

The port 18 is preferably a field bus port which connects with the industrial automated plant via a field bus over which information can be exchanged through a field bus protocol.

Furthermore, the circuit board 16 is connected to two signal lamps 19a, 19b, which are arranged in a downwardly projecting region of the rocker 13. The two signal lamps 19a, 19b are each associated with one side of the rocker 13 and are activated by pulling on a respective eyelet 15a or 15b. The signal lamps 19a, 19b in FIG. 1 may include incandescent bulbs. Preferably, the signal lamps 19a, 19b include one or more light-emitting diode. In other embodiments, there may be a single signal lamp or more than two signal lamps. Signal lamps may also be present in different colors in order to signal different activation states of the switch 10.

In one embodiment, the signal lamps 19a, 19b are activated by the circuit 16a arranged on the circuit board 16 immediately after evaluating signals of the accelerometer 17. In another embodiment, the signal lamps 19a, 19b are activated via the circuit board 16 and input signals from the port 18. In such a scenario, when the switch 10 is triggered, the evaluation circuit on the circuit board 16 relays the event to the control system via the ports 18, the control system responds to the event and halts the automated plant or places it in a safe mode, and sends an input signal to the port 18 to have the circuit board 16 turn on the signal lamps 19a, 19b.

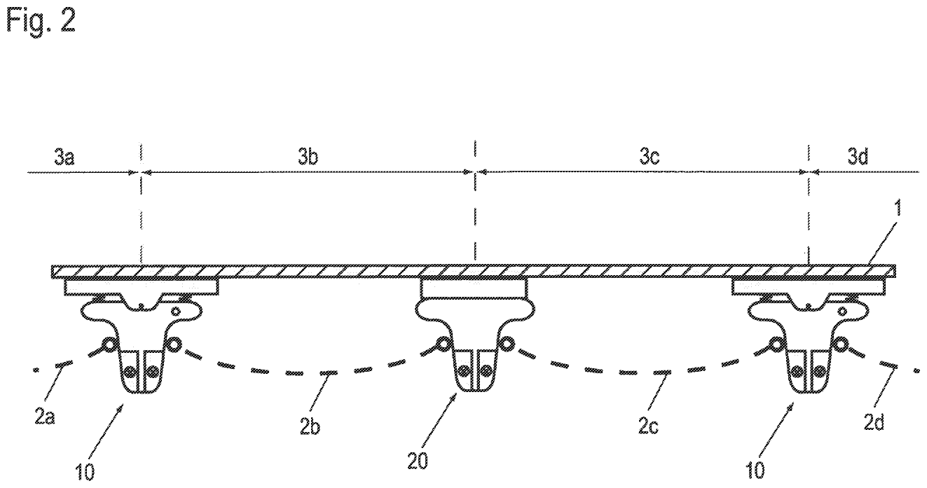

With the aid of the polarity or the time variation of the polarity of the accelerometer signal, it is possible to distinguish which rip cord 2a or 2b is activated, or in other words, to which side the rocker 13 swivels. This information, properly encoded, is output through the port 18. It is then possible to activate only the signal lamp 19a, 19b associated with the corresponding side of the rocker 13 and thus the activated rip cord 2a or 2b, so that it is immediately evident which section of the rip cord 2a, 2b was pulled. This is further explained below in connection with FIG. 2.

In addition to determining that a rip cord 2a, 2b has been activated, or which of the rip cords 2a, 2b has been activated, evaluating the time variation and the strength of the signal of the accelerometer 17 detects different activation states that are output via the port 18. For example, it is conceivable to distinguish a light pull on the rip cord 2a, 2b from a strong pull on the rip cord 2a, 2b, which is determined by the magnitude of the measured acceleration values. Further, a timer 38 can measure the time elapsed between the movement of the rocker 13 from the base position until the rocker 13 comes to a stop at maximum swivel, to obtain inferences as to the activation dynamics.

For a slight pull, for example, the automated plant may only be switched to a slower and thus safer mode, whereas for a strong pull on the rip cord, the plant is halted at once. Alternatively, a slight pull may also serve for signaling purposes in process optimization and a firmer pull can initiate an emergency shutdown.

Furthermore, in another embodiment, short activations of one of the rip cords 2a, 2b is provided in succession to detect and output a special activation signal. Such multiple activations may involve, for example, special operating modes of the automated plant, which are used in the course of machine setup or process optimization.

In an alternative embodiment, the switch 10 is configured with only one eyelet 15a or 15b for use on only one side. In this case, the rocker 13 is preloaded with only with one of the springs 14a, 14b, so that it can swivel from a base position in one direction.

In yet another embodiment, eyelets 15a, 15b may be provided on both sides of the rocker 13 and the rocker can swivel in both directions, but only a single common signal lamp is provided. The lamp is preferably activated for both directions. A separate evaluation is then made as to the direction in which the rocker 13 has moved. In yet another embodiment, it may also be provided that only an activation of the rocker 13 is detected, without distinguishing the direction in which this activation occurs.

FIG. 2 shows an assembly of multiple switches 10 as the type shown in FIG. 1. For example, an assembly with two switches 10 and four rip cords 2a to 2d is shown. With such an assembly, a safety shutdown can be provided for a large automated plant along an extended portion of the plant.

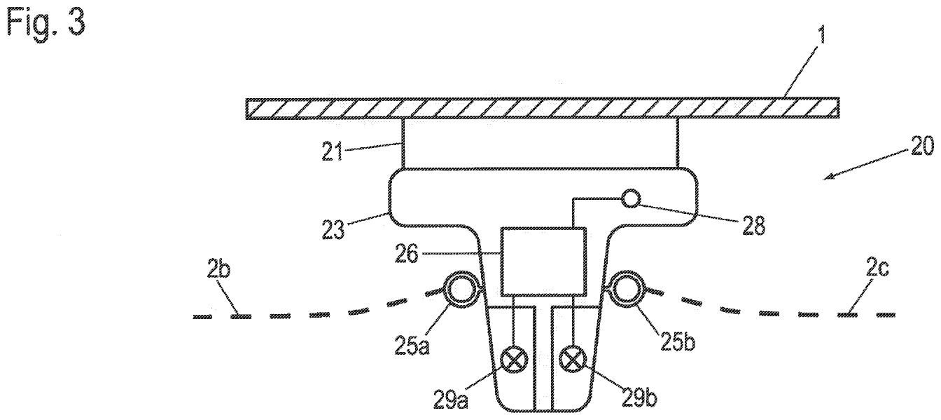

In the example shown, the switches 10 alternate with safety lights 20. Each of the rip cords 2a to 2d is fastened at one end to one of the switches 10 and at the other end to one of the safety lights 20. The safety lights 20 include cord connectors for the rip cords 2a to 2d, but cannot themselves detect when the rip cords 2a to 2d have been activated. In addition to the connectors, the safety lights also have a signaling function and corresponding signal lamps comparable to the signal lamps 19a, 19b of the switches 10 (as also shown in FIG. 3).

When one of the rip cords 2a to 2d in the assembly of FIG. 2 is activated, the switch 10 connected to the associated rip cord swivels and relays a signal to the control system (or safety control system) of the automated plant. This halts the operation of the automated plant or places it in a safe operating state. A signal is then sent to the respective switch 10, as well as the safety light 20 to which the other end of the activated rip cord 2a to 2d is fastened.

Therefore, it is possible to clearly identify a respective section 3a to 3d associated with a rip cord 2a to 2d. For example, if the rip cord 2b is activated, this is detected by the switch 10 that is between rip cords 2a and 2b. Once detected, the right signal lamp 19b (shown in FIG. 1) of the switch 10 as well as the left signal lamp 29a (shown in FIG. 3) of the safety light 20, which is between rip cords 2b and 2c of FIG. 2, are activated.

FIG. 3 shows one embodiment of a safety light 20 used in the assembly of FIG. 2. The safety light 20 has a baseplate 21 for mounting the light on the carrier 1 of the automated plant. The baseplate 21 is connected to a housing 23, which is shaped similar to the rocker 13 of the switch 10, but is not swivel-mounted. There are respective eyelets 25a, 25b arranged on sides of the housing 23, with which rip cord 2b and 2c are connected. Furthermore, the housing 23 includes a port 28 which communicates with signal lamps 29a, 29b via a circuit board 26 with electronic components. When a rip cord 2b, 2c is pulled, the port 28 communicates with the circuit board 26 to activate the signal lamps 29a, 29b.

In the above described examples, the switching status of the switch 10 is identified by the evaluation circuit on the circuit board 16 and transmitted to the automated plant—preferably using a field bus protocol. The signals measured by the accelerometer 17 such as after a preprocessing can also be output via the port 18, and can be retrieved via the field bus protocol. This information can be used to detect irregularities of the automated plant, such as unusually strong vibrations of the carrier 1, which are transmitted to the accelerometer 17.

Although the above description is with reference to particular embodiments, it is to be understood that these embodiments are merely illustrative of the principles and applications of the present disclosure. It is therefore to be understood that numerous modifications may be made to the illustrative embodiments and that other arrangements may be devised and employed without departing from the spirit and scope of the present disclosure.

1-17. (canceled)

18. A safety switch for an automated industrial plant, comprising
(a) a rocker connected with a swivel joint for pivotal movement;
(b) an accelerometer mounted on said rocker for detecting movement of said rocker about said swivel joint; and
(c) at least one cord connector arranged on a side of said rocker, whereby when a cord is connected with said cord connector and pulled, said rocker swivels in a first direction via said swivel joint and said accelerometer identifies movement in said rocker.

19. A safety switch as defined in claim 18, wherein said accelerometer comprises a micro electric mechanical system sensor.

20. A safety switch as defined claim 18, has and further comprising an evaluation circuit mounted on said rocker and connected with said accelerometer for evaluating an output signal from said accelerometer corresponding with the detected movement.

21. A safety switch as defined in claim 20, wherein said evaluation circuit comprises at least one threshold value detector for determining a swivel movement of said rocker.

22. A safety switch as defined in claim 21, wherein said evaluation circuit comprises at least two threshold value detectors for determining at least two swivel movements of said rocker.

23. A safety switch as defined in claim 21, wherein said evaluation circuit comprises a timer for determining an amount of time during which an acceleration value of said accelerometer is above a threshold.

24. A safety switch as defined in claim 22, wherein said evaluation circuit comprises a timer for determining an amount of time during which an acceleration value of said accelerometer is between a first and a second threshold.

25. A safety switch as defined in claim 18, has and further comprising a pair of pretensioned springs connected with said rocker on opposite sides of said swivel joint to maintain said rocker in a neutral position.

26. A safety switch as defined in claim 25, wherein said rocker includes two cord connectors on opposite sides of said rocker for connection with respective rip cords, whereby operation of said rip cords swivels said rocker in opposite directions from said neutral position.

27. A safety switch as defined in claim 26, wherein said evaluation circuit receives output signals from said accelerometer and determines a side to which said rocker swivels.

28. A safety switch as defined in claim 20, and further comprising at least one signal lamp for signaling a switching status of the safety switch in response to movement of said rocker.

29. A safety switch as defined in claim 28, and further comprising two signal lamps for identifying respective sides of said rocker.

30. A safety switch as defined in claim 28, and further comprising an industrial field bus port connected with said evaluation circuit for transmitting a switching status of said safety switch.

31. A safety switch as defined in claim 30, wherein said industrial field bus port controls said at least one signal lamp via an industrial field bus.

32. A safety switch assembly comprising a safety switch as defined claim 18 and a first rip cord connected with said safety switch cord connector.

33. A safety switch assembly comprising first and second safety switches as defined in claim 18 and first and second rip cords connected with said first and second safety switch cord connector, respectively; and
(a) a safety light including
(1) a first cord connector arranged on a first side of said safety light and connected with said first rip cord;
(2) a second cord connector arranged on a second side of said safety light and connected with said second rip cord; and
(3) at least one signal lamp operated in response to movement of said safety switches.

34. The assembly according to claim 33, wherein said safety light further includes an industrial field bus port for controlling said at least one signal lamp via an industrial field bus.
